(19) United States
(12) Patent Application Publication
(10) Pub. No.: US 2006/0072898 A1
(43) Pub. Date: Apr. 6, 2006

(54) Information managing apparatus, information managing program, and recording medium

(76) Inventors: Yuji Horie, Tokyo (JP); Toshiaki Wada, Tama-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/243,682

(22) Filed: Oct. 5, 2005

(30) Foreign Application Priority Data
Oct. 6, 2004 (JP) 2004-294019

(51) Int. Cl. H04N 5/781

(52) U.S. Cl. 386/46; 386/125

(57) ABSTRACT

On the basis of an information managing database configured to store information on a plurality of multimedia contents stored by a content memory of an information reproducing apparatus and information on multimedia contents stored by an information memory of an information managing apparatus, a content managing unit of the information managing apparatus extracts from the information memory contents acquired by the information reproducing apparatus that are types reproducible by a content reproducing unit of the information reproducing apparatus but that are not stored in the content memory of the information reproducing apparatus from among the contents stored in the information memory, and transmits to the information reproducing apparatus all of the extracted contents or a part of contents which is selected by user from among the extracted contents.

### CROSS-REFERENCE TO RELATED APPLICATIONS

This application is based upon and claims the benefit of priority from prior Japanese Patent Application No. 2004-294019, filed Oct. 6, 2004, the entire contents of which are incorporated herein by reference.

### BACKGROUND OF THE INVENTION

1. Field of the Invention

The present invention relates to an information managing apparatus that manages a plurality of contents (content data) to be stored by an information reproducing apparatus for reproducing multimedia contents, an information managing program that is executed by such an information managing apparatus, and a recording medium that can be read by a computer and stores therein a program for causing the computer to function as such an information managing apparatus.

2. Description of the Related Art

For example, as disclosed in US 2003/0167318 A1, in a terminal device such as a music reproduction terminal having a hard disk, management of stored contents is carried out by an information managing apparatus such as a host PC according to synchronous processing. According to this synchronous processing, the terminal device is connected to the information managing apparatus and the contents to be stored in the terminal device are made equal to those stored in the information managing apparatus. In this case, the contents not stored in the terminal device are collectively transmitted from the information managing apparatus.

### BRIEF SUMMARY OF THE INVENTION

According to a first aspect of the present invention, there is provided an information managing apparatus comprising:

a communication unit configured to transmit and receive information to and from an information reproducing apparatus having a content memory configured to store a plurality of multimedia contents and a content reproducing unit configured to reproduce the contents;

an information memory configured to store information including the multimedia contents;

an information managing database configured to store information on the contents stored by the content memory of the information reproducing apparatus and information on the contents stored by the information memory;

a content managing unit configured to manage the contents stored in the content memory of the information reproducing apparatus connected to the communication unit, on the basis of the information stored in the information managing database; and

a content type acquiring means configured to acquire from the information reproducing apparatus information on the type of the content that can be reproduced by the content reproducing unit of the information reproducing apparatus, wherein

the content managing unit extracts from the information memory the contents acquired by the content type acquiring means that are types reproducible by the content reproducing unit of the information reproducing apparatus but that are not stored in the content memory of the content reproducing unit from among the contents stored in the information memory, on the basis of the information managing database, and

transmits to the information reproducing apparatus by the communication unit one of all of the extracted contents and a part of contents which is selected by user from among the extracted contents.

According to a second aspect of the present invention, there is provided an information managing program to be executed by an information managing apparatus comprising: a communication unit configured to transmit and receive information to and from an information reproducing apparatus having a content memory configured to store a plurality of multimedia contents and a content reproducing unit configured to reproduce the contents; an information memory configured to store information including the multimedia contents; and an information managing database configured to store information on the contents stored by the content memory and information on the contents stored by the information memory, the information managing program comprising:

connecting the information managing apparatus to the information reproducing apparatus by the communication unit;

acquiring information on a type of the content that can be reproduced by the content reproducing unit of the information reproducing apparatus from the connected information reproducing apparatus;

selecting the contents that are types reproducible by the content reproducing unit of the information reproducing apparatus but that are not stored in the content memory of the information reproducing apparatus from among the contents stored in the information memory on the basis of the information managing database;

extracting the selected contents from the information memory; and

transmitting to the information reproducing apparatus one of all of the extracted contents and a part of contents which is selected by user from among the extracted contents.

According to a third aspect of the present invention, there is provided a recording medium that can be read by a computer comprising: a communication unit configured to transmit and receive information to and from an information reproducing apparatus having a content memory configured to store a plurality of multimedia contents and a content reproducing unit configured to reproduce the contents; an information memory configured to store information including the multimedia contents; and an information managing database configured to store information on the contents stored by the content memory and information on the contents stored by the information memory, and that stores therein a program including commands that makes the computer execute:

connecting to the information reproducing apparatus by the communication unit;

acquiring information on a type of the content that can be reproduced by the content reproducing unit of the information reproducing apparatus from the connected information reproducing apparatus;

selecting the contents that are types reproducible by the content reproducing unit of the information reproducing apparatus but that are not stored in the content memory of the information reproducing apparatus from among the contents stored in the information memory on the basis of the information managing database;

extracting the selected contents from the information memory; and

transmitting to the information reproducing apparatus one of all of the extracted contents and a part of contents which is selected by user from among the extracted contents.

According to a fourth aspect of the present invention, there is provided an information managing apparatus comprising:

communication means for transmitting and receiving information to and from an information reproducing apparatus having first storage means for storing a plurality of multimedia contents and content reproducing means for reproducing the contents;

second storage means for storing information including the multimedia contents;

an information managing database for storing information on the contents stored by the first storage means of the information reproducing apparatus and information on the contents stored by the second storage means;

content managing means for managing the contents stored in the first storage means of the information reproducing apparatus connected to the communication means, on the basis of the information stored in the information managing database; and

content type acquiring means for acquiring from the information reproducing apparatus information on the type of the content that can be reproduced by the content reproducing means of the information reproducing apparatus, wherein

the content managing means extracts from the second storage means the contents acquired by the content type acquiring means that are types reproducible by the content reproducing means of the information reproducing apparatus but that are not stored in the first storage means of the content reproducing means from among the contents stored in the second storage means, on the basis of the information managing database, and

transmits to the information reproducing apparatus by the communication means one of all of the extracted contents and a part of contents which is selected by user from among the extracted contents.

According to a fifth aspect of the present invention, there is provided an information managing program to be executed by an information managing apparatus comprising: a communication means for transmitting and receiving information to and from an information reproducing apparatus having a first storage means for storing a plurality of multimedia contents and content reproducing means for reproducing the contents; second storage means for storing information including the multimedia contents; and an information managing database for storing information on the contents stored by the first storage means and information on the contents stored by the second storage means, the information managing program comprising:

connecting the information managing apparatus to the information reproducing apparatus by the communication means;

acquiring information on a type of the content that can be reproduced by the content reproducing means of the information reproducing apparatus from the connected information reproducing apparatus;

selecting the contents that are types reproducible by the content reproducing means of the information reproducing apparatus but that are not stored in the first storage means of the information reproducing apparatus from among the contents stored in the second storage means on the basis of the information managing database;

extracting the selected contents from the second storage means; and

transmitting to the information reproducing apparatus one of all of the extracted contents and a part of contents which is selected by user from among the extracted contents.

According to a sixth aspect of the present invention, there is provided a recording medium that can be read by a computer comprising: communication means for transmitting and receiving information to and from an information reproducing apparatus having first storage means for storing a plurality of multimedia contents and content reproducing means for reproducing the contents; second storage means for storing information including the multimedia contents; and an information managing database for storing information on the contents stored by the first storage means and information on the contents stored by the second storage means, and that stores therein a program including commands that makes the computer execute:

connecting to the information reproducing apparatus by the communication means;

acquiring information on a type of the content that can be reproduced by the content reproducing means of the information reproducing apparatus from the connected information reproducing apparatus;

selecting the contents that are types reproducible by the content reproducing means of the information reproducing apparatus but that are not stored in the first storage means of the information reproducing apparatus from among the contents stored in the second storage means on the basis of the information managing database;

extracting the selected contents from the second storage means; and

transmitting to the information reproducing apparatus one of all of the extracted contents and a part of contents which is selected by user from among the extracted contents.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a configuration of an information managing apparatus according to a first embodiment of the present invention and a terminal device as an information reproducing apparatus that is transferred, stores, and reproduces multimedia contents managed by the information managing apparatus;

FIG. 2 is a diagram showing a configuration of a memory of a device management DB of the information managing apparatus according to the first embodiment;

FIG. 3 is a view showing a management screen that is displayed on a display by a display unit of the information managing apparatus according to the first embodiment;

FIG. 4 is a flowchart of a main routine explaining the operation of a processing unit of the information managing apparatus according to the first embodiment;

FIG. 5 is a detailed flowchart of a management screen display subroutine shown in FIG. 4;

FIG. 6 is a detailed flowchart of a content selection subroutine shown in FIG. 4;

FIG. 7 is a detailed flowchart of a synchronization processing subroutine shown in FIG. 4;

FIG. 8 is a view showing a management screen in an information managing apparatus according to a second embodiment of the present invention;

FIG. 9 is a detailed flowchart of a management screen display subroutine according to the second embodiment;

FIG. 10 is a detailed flowchart of a content selection subroutine according to the second embodiment; and

FIG. 11 is a detailed flowchart of a synchronization processing subroutine according to the second embodiment.

### DETAILED DESCRIPTION OF THE INVENTION

Preferred embodiments of the present invention will be described below with reference to the accompanying drawings.

### First Embodiment

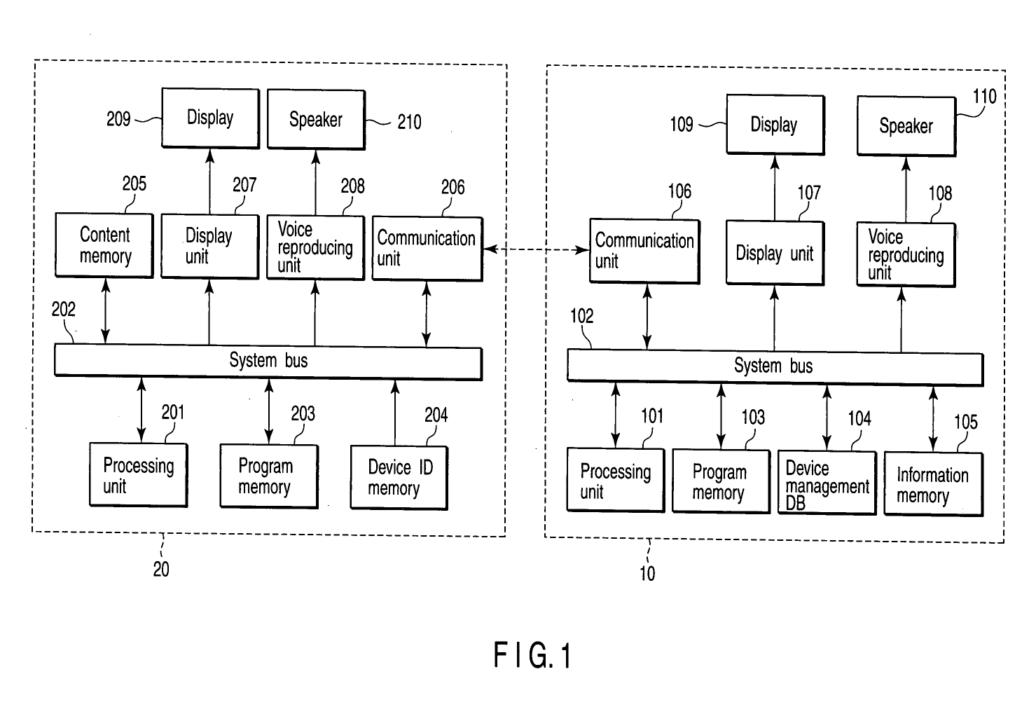

FIG. 1 is a diagram showing a configuration of an information managing apparatus 10 according to a first embodiment of the present invention and a terminal device 20 as an information reproducing apparatus that is transferred, stores, and reproduces multimedia contents managed by the information managing apparatus 10.

The information managing apparatus 10 is implemented by a personal computer (PC). The information managing apparatus 10 is provided with a processing unit 101 such as a CPU. Then, a program memory 103, a device management database (DB) 104, an information memory 105, a communication unit 106, a display unit 107, and a voice reproducing unit 108 are connected to the processing unit 101 via a system bus 102.

Here, the program memory 103 stores various control programs including an information management program according to the present embodiment that is executed by the processing unit 101. The device management DB 104 stores various information for managing the terminal device 20 to be connected to the information managing apparatus 10 and multimedia contents to be stored by the terminal device 20. The information memory 105 is implemented by a hard disk drive (HDD) and stores various multimedia contents such as image content, video content, and voice content. The communication unit 106 transmits and receives data to and from the terminal device 20 with or without wires. The communication unit 106 is, for example, a USB interface, and has a function of detecting that the terminal device 20 is connected to the information managing apparatus 10. The display unit 107 displays the image content, the video content, and further, various operation screens on a display 109. The voice reproducing unit 108 causes a speaker 110 to output a voice included in the voice content and the video content.

In addition, the terminal device 20 has a processing unit 201 such as a CPU. Further, a program memory 203, a device ID memory 204, a content memory 205, a communication unit 206, a display unit 207, and a voice reproducing unit 208 are connected to the processing unit 201 via a system bus 202.

In this case, the program memory 203 stores various control programs to be executed by the processing unit 201 and also stores information on types of the contents that can be reproduced by the terminal device 20. The reproducible contents may be updated by update of a firmware. The device ID memory 204 stores a device ID that is identical to each terminal device in order to specify the terminal device 20. The device ID is stored so as not to be rewritten. The content memory 205 is implemented by an HDD or a large-capacity semiconductor memory, and stores various multimedia contents transferred from the information managing apparatus 10. The communication unit 206 transmits and receives data to and from the information managing apparatus 10 with or without wires. The display unit 207 displays image content and video content on a display 209 such as a liquid crystal. The voice reproducing unit 208 causes a speaker 210 to output the voice included in the voice content and the video content.

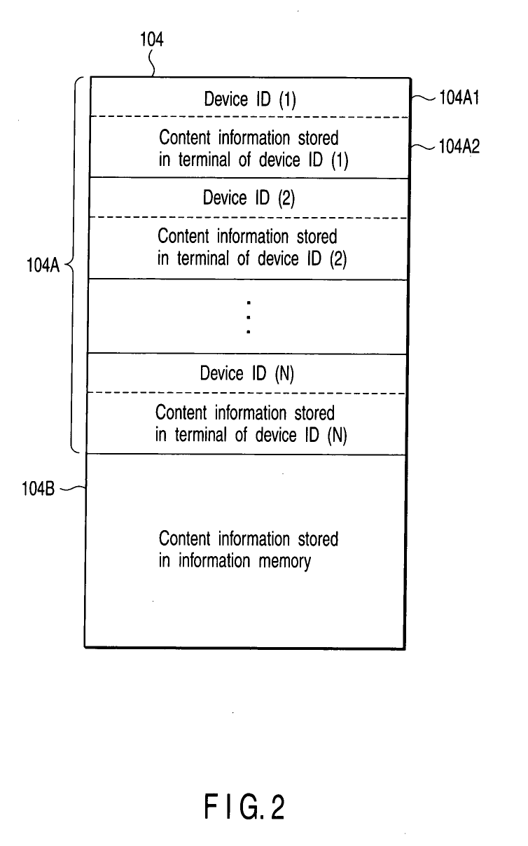

As shown in FIG. 2, the device management DB 104 of the information managing apparatus 10 stores therein device management information 104A for each terminal device 20 that is registered as a device to be connected to the information managing apparatus 10 and host content information 104B indicating what the content stored in the information memory 105 is. In this case, the device management information 104A for each terminal device 20 includes a device ID 104A1 for specifying the terminal device 20 and device content information 104A2 indicating what the content stored in the content memory 205 of the relevant terminal device 20 is.

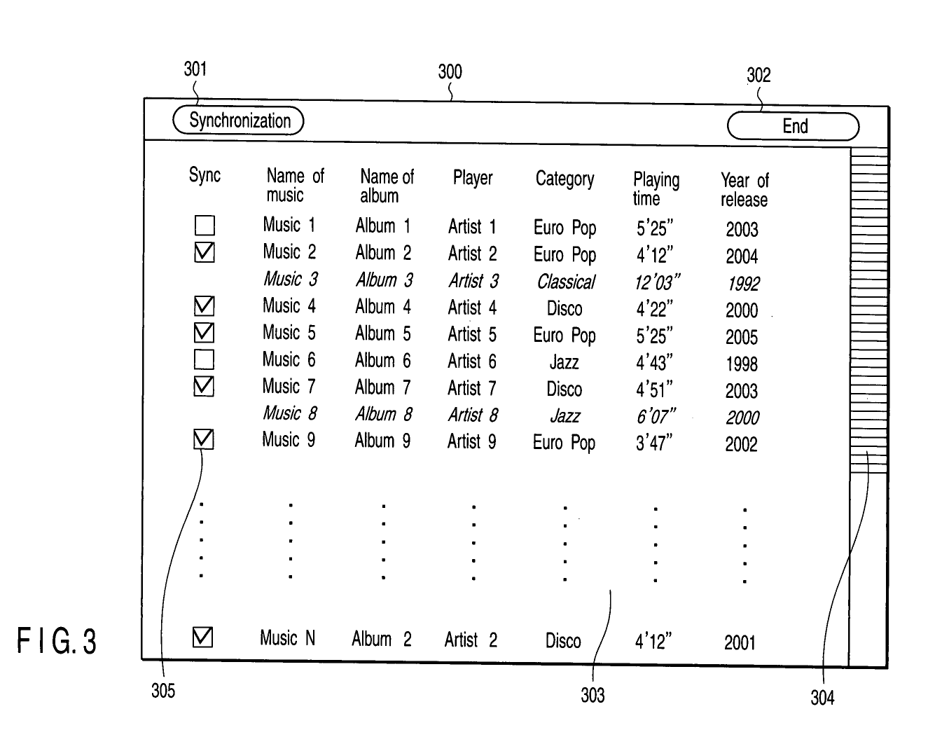

As shown in FIG. 3, a management screen 300 displayed on the display 109 by the display unit 107 of the information managing apparatus 10 has a synchronization button 301 and an end button 302 that are turned ON by clicking operation of a mouse (not illustrated) on its upper part. Under these buttons, a list of indexes showing the contents of the multimedia content stored in the information memory 105 managed by the host content information 104B of the device management DB 104 is displayed as a content list 303. In the meantime, a scroll bar 304 located at the right side of the management screen 300 serves to display the information of the contents that cannot be displayed on one screen by scrolling. In addition, at the left side of the information of each content in the content list 303, synchronization check boxes 305 are arranged as indexes. The management screen 300 indicates that the content having its synchronization check box 305 checked is to be transferred (copied) to the terminal device 20. A user can select whether the synchronization box 305 is checked or not by the clicking operation of the mouse.

Although FIG. 3 illustrates the content list of the voice content, the image content and the video content can be also listed, and it is a mater of course that the image content, the video content, and the voice content are allowed to be mixed and displayed.

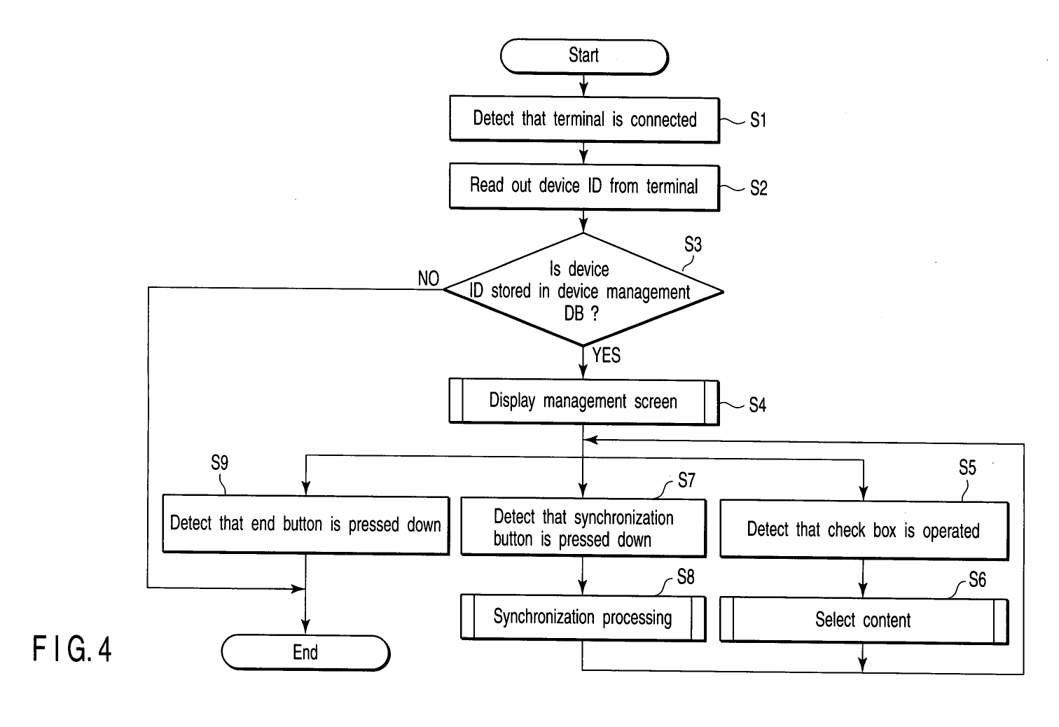

Next, the operation in accordance with the information management program stored in the program memory 103 will be described with reference to a flowchart of FIG. 4.

First, when the communication unit 106 detects that the terminal device 20 is connected to the information managing apparatus 10 (step S1), the device ID stored in the device ID memory 204 is read out from the terminal device 20 (step S2). That is, transmission of the device ID from the terminal device 20 is requested, then, the transmitted device ID is received.

Next, it is determined whether or not the device ID is stored in the device management DB 104 (step S3). If the device ID is not stored, the processing is terminated. It is a matter of course that the device ID is newly registered in the device management DB 104.

If the device ID is stored in the device management DB 104 (step S3), a management screen display subroutine (to be described in detail later) is carried out (step S4). Then, operation by the user is awaited.

If it is detected that the synchronization check box 305 of the management screen 300 is operated (step S5), a content selection subroutine (to be described in detail later) is carried out (step S6). Then, operation by the user is awaited again.

Further, if it is detected that the synchronization button 301 of the management screen 300 is detected (step S7), a synchronization processing subroutine (to be described in detail later) is carried out (step S8). Then, operation by the user is awaited again.

Then, if it is detected that the end button 302 of the management screen 300 is pressed down (step S9), the processing is terminated.

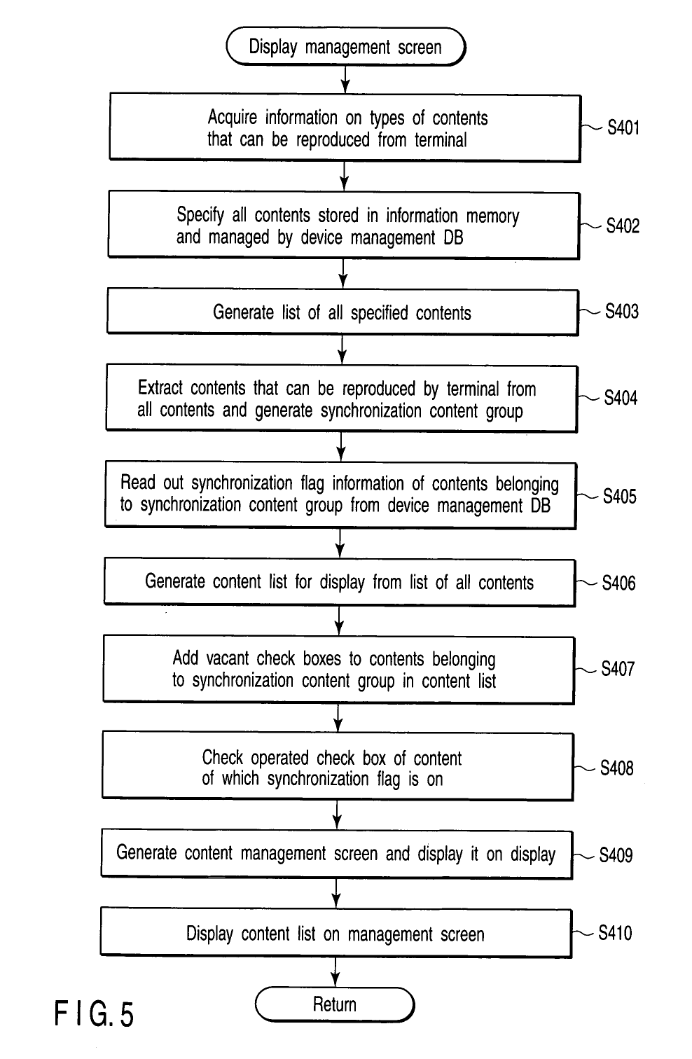

In the management screen display subroutine invoked in the step S4, first, the information on types of the contents that can be reproduced from the terminal device 20 is acquired as shown in FIG. 5 (step S401). In this case, the communication unit 106 requires transmission of the information on types of the contents that can be reproduced from the terminal device 20. In accordance with the transmission request, the reproducible information on types of the contents stored in the program memory 203 is read out by the terminal device 20 and transmitted, so that the information is received by the communication unit 106 in the same way to be held in an inner memory or the like of the processing unit 101.

Next, all the contents are specified, the contents being stored in the information memory 105 and managed by the device management DB 104 with the host content information 104B (step S402). Then, a list of all the specified contents is generated, and the list is held in the inner memory or the like of the processing unit 101 (step S403).

Thereafter, in accordance with the acquired information on types of the contents that can be reproduced by the terminal device 20, the content that can be reproduced by the terminal device 20 is extracted from the list of all the contents, and a synchronization content group is generated and held in the inner memory or the like of the processing unit 101 (step S404). Then, synchronization flag information of the contents belonging to the generated content group is read out by the device management DB 104 (step S405).

In this case, the synchronization flag is a variable stored as a part of the device content information 104A2 of the device management DB 104 for each terminal device corresponding to each content stored in the information memory 105 of the information managing apparatus 10. The fact that the synchronization flag of a certain content is on means that the content is also stored in the content memory 205 of the terminal device 20. The fact that the synchronization flag is off means that the content is stored in the information memory 105 of the information managing apparatus 10 but is not stored in the content memory 205 of the terminal device 20. The user can operate this synchronization flag by the synchronization check box 305 of the management screen 300. If the synchronization check box 305 is checked, the synchronization flag is turned on, and if the synchronization check box 305 is unchecked, the synchronization flag is turned off. Further, the synchronization content group merely means a set of all contents that can be reproduced by the terminal device 20. Accordingly, in step S405, due to the device content information 104A2 of the terminal device 20 of the device management DB 104, the synchronization flag information of this terminal device 20 is extracted.

Subsequently, from the list of all the contents generated in step S403, a content list for display is generated (step S406). Then, to the contents belonging to the synchronization content group generated in step S404, vacant synchronization check boxes are added (step S407). Thereafter, the synchronization check box of the content of which synchronization flag is on from among the vacant synchronization check boxes is checked (step S408).

Then, the management screen 300 is displayed on the display 109 (step S409), the content list 303 including the synchronization check box 305 is displayed on the management screen 300 (step S410), and the processing returns to the upper routine.

In this time, as shown in FIG. 3, the content list 303 is displayed such that the index of the content that cannot be reproduced by the terminal device 20 (for example, “Music 3” and “Music 8”), namely, the index of the content not belonging to the synchronization content group is displayed with a lower brightness or a lower saturation as compared to the index of the content that can be reproduced by the terminal device 20 (in the drawing, the lower brightness or the lower saturation is represented by an italic letter). Thus, the user can easily confirm the content that cannot be synchronized. Since the check box is not added to the content not belonging to the synchronization content group in step S407, the synchronization check box 305 is not also displayed and cannot be selected.

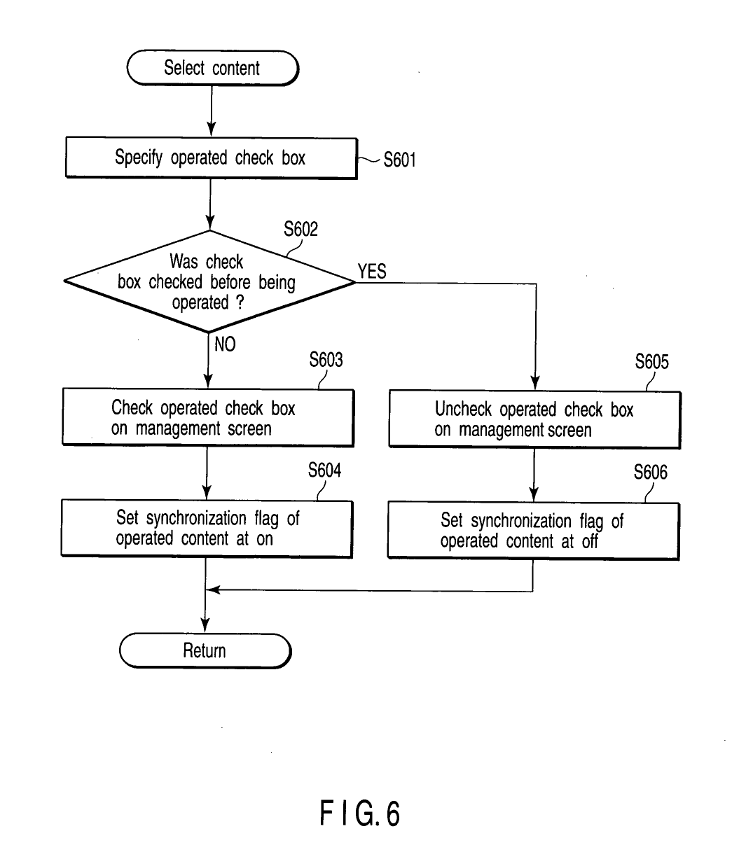

In the content selection subroutine invoked in step S6, first, the operated synchronization check box 305 is specified as shown in FIG. 6 (step S601). Then, it is discriminated that the specified synchronization check box 305 was checked before it is operated (step S602).

If the specified synchronization check box 305 was not checked before the operation, the operated synchronization check box 305 on the management screen 300 displayed on the display 109 by the display unit 107 is checked (step S603). Then, after setting the synchronization flag of the operated content at on (step S604), the processing returns to the upper routine.

Further, in the case where it is discriminated that the specified synchronization check box 305 was checked before the operation (step S602), the operated synchronization check box 305 on the management screen 300 displayed on the display 109 by the display unit 107 is unchecked (step S605). Then, after setting the synchronization flag of the operated content at off (step S606), the processing returns to the upper routine.

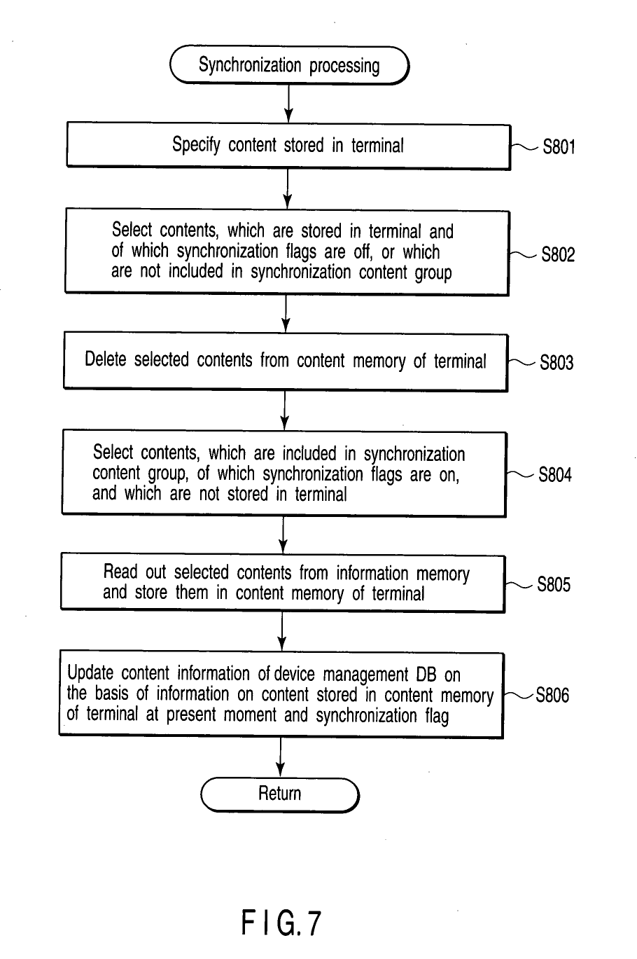

In the synchronization processing subroutine invoked in step S8, first, the information of the content stored in the content memory 205 of the terminal device 20 is acquired from the terminal device 20 via the communication unit 106 to specify the content actually stored in the terminal device 20 as shown in FIG. 7 (step S801). This is because the terminal device 20 or the information managing apparatus 10 may delete the content independently, and the information of the content stored in the content memory 205 of the device content information 104A2 stored in the device management DB 104 of the information managing apparatus 10 does not coincide with the information actually stored in the content memory 205 of the terminal device 20.

Further, the contents are selected, which are stored in the terminal device 20 and of which synchronization flags are off, or which are not included in the synchronization content group (step S802). Then, the selected contents are deleted from the content memory 205 of the terminal device 20 (step S803). This deletion is carried out in such a manner that a deletion request is transmitted to the terminal device 20 by the communication unit 106 and the processing unit 201 of the terminal device 20 having received this deletion request actually deletes the content from the content memory 205.

Next, the contents are selected, which are included in the synchronization content group, of which synchronization flags are on, and which are not stored in the content memory 205 of the terminal device 20 (step S804). Then, the selected contents are read out from the information memory 105, and stored in the content memory 205 of the terminal device 20 (step S805). This is carried out in such a manner that the read contents are transmitted to the terminal device 20 by the communication unit 106 and the processing unit 201 of the terminal device 20 having received the read contents stores them in the content memory 205.

Thereafter, the device content information 104A2 of the terminal device 20 of the device management DB 104 is updated on the basis of the information of the content stored in the content memory 205 of the terminal device 20 at the present moment and the synchronization flag (step S806), and the processing is returned to the upper routine.

As described above, the information managing apparatus 10 according to the first embodiment of the invention acquires the information on types of the contents that can be reproduced by the terminal device 20 and displays the content list 303 set to be unable to select the contents that cannot be reproduced by the terminal device 20. Accordingly, the user can synchronize the terminal device 20 with the information managing apparatus 10 without being aware of a file format of the content. In addition, the user can easily confirm the content that cannot be synchronized.

### Second Embodiment

Next, a second embodiment of the present invention will be described below. According to this embodiment, with respect to the content that cannot be copied due to a copyright, content movement can be selected.

Since the configuration of the embodiment is the same as the above-described first embodiment, its explanation is herein omitted.

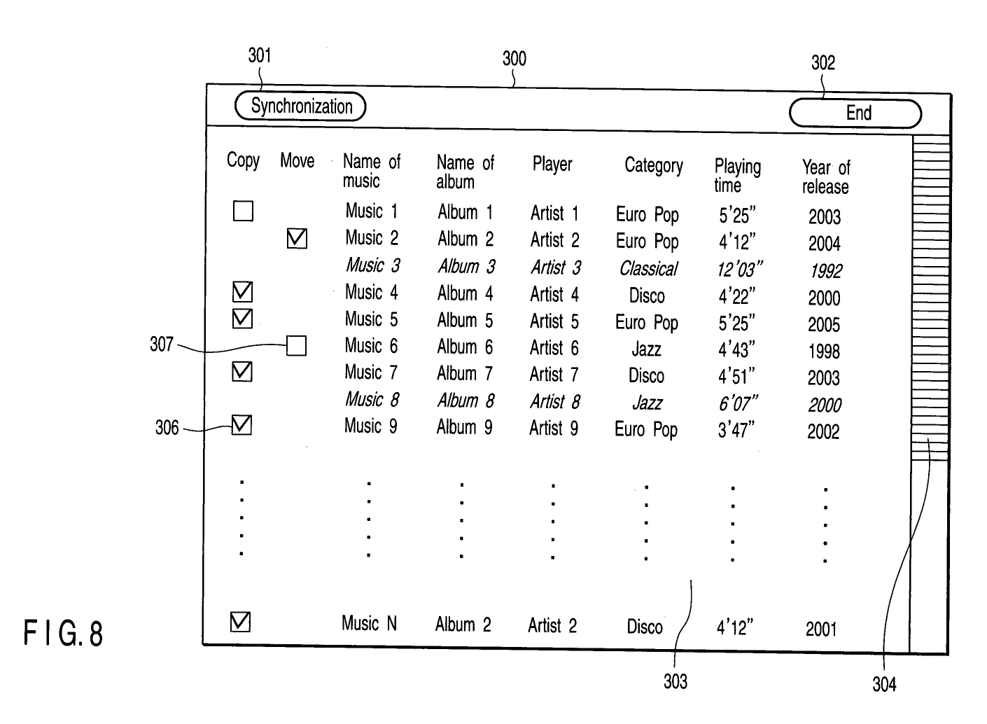

As shown in FIG. 8, on the management screen 300 according to the embodiment, a copy check box 306 and a moving check box 307 are displayed in place of the synchronization check box 305 according to the first embodiment. Here, if the copy check box 306 is checked, the content is stored in the terminal device 20 and the information managing apparatus 10, and if the copy check box 306 is unchecked, namely, it is vacant, the content is stored only in the information managing apparatus 10. In addition, if the moving check box 307 is checked, the content is stored only in the terminal device 20, and if the moving check box 307 is unchecked, namely, it is vacant, the content is stored only in the information managing apparatus 10.

Hereinafter, the processing of the processing unit 101 in the information managing apparatus 10 for carrying out such an operation will be described.

Since a main routine of the information management program stored in the program memory 103 and executed by the processing unit 101 is the same as the flowchart of FIG. 4 according to the above-described first embodiment, its explanation is herein omitted.

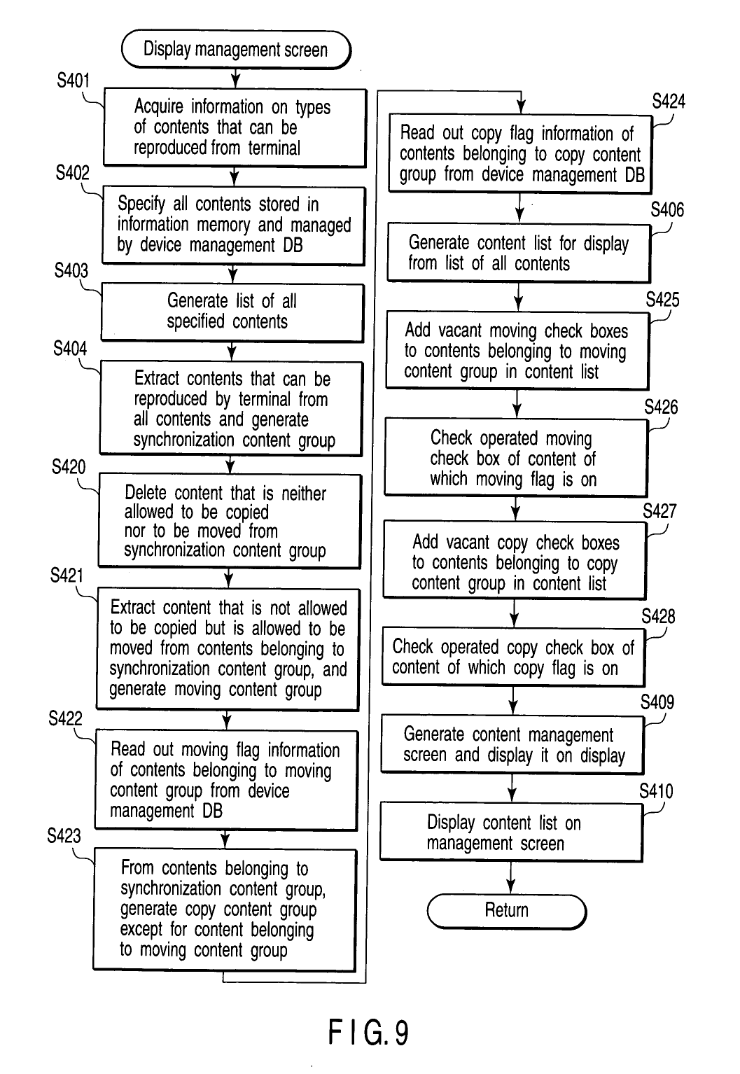

According to the embodiment, the management screen display subroutine invoked in the step S4 of this main routine is as shown in FIG. 9. Further, since steps S401 to S404 are the same processings as those explained in FIG. 5, their explanations are herein omitted.

If a synchronization content group is generated in step S404, then, the content that is neither allowed to be copied nor to be moved is deleted from the synchronization content group (step S420).

Next, the content that is not allowed to be copied but is allowed to be moved is extracted from the content belonging to the synchronization content group, and a moving content group is generated (step S421). In this case, the moving content group means a set of all contents that cannot be copied so as to be reproducible in the terminal device 20 but can be moved. Then, the moving flag information of the content belonging to the moving content group is read out from the device management DB 104 (step S422). Here, the moving flag is a variable stored as a part of the device content information 104A2 of the device management DB 104 for each terminal device corresponding to each content stored in the information memory 105 of the information managing apparatus 10. The fact that the moving flag of a certain content is on means that the content is not stored in the information memory 105 of the information managing apparatus 10 but is stored in the content memory 205 of the terminal device 20. The fact that the moving flag is off means that the content is not stored in the content memory 205 of the terminal device 20 but is stored in the information memory 105 of the information managing apparatus 10. The user can operate the moving flag by the moving check box 307 of the management screen 300. If the moving check box 307 is checked, the moving flag is turned on, and if the moving check box 307 is unchecked, the moving flag is turned off. Accordingly, in step S422, due to the device content information 104A2 of the terminal device 20 of the device management DB 104, the moving flag information of the terminal device 20 is extracted.

Next, from the content belonging to the synchronization content group, a copy content group except for the contents belonging to the moving content group is generated (step S423). Then, the copy flag information of the contents belonging to the copy content group is read out from the device management DB 104 (step S424). Here, the copy flag is a variable stored as a part of the device content information 104A2 of the device management DB 104 for each terminal device corresponding to each content stored in the information memory 105 of the information managing apparatus 10. The fact that the copy flag of a certain content is on means that the content is also stored in the content memory 205 of the terminal device 20. The fact that the copy flag is off means that the content is stored in the information memory 105 of the information managing apparatus 10 but is not stored in the content memory 205 of the terminal device 20. The user can operate this synchronization flag by the copy check box 306 of the management screen 300. If the copy check box 306 is checked, the synchronization flag is turned on, and if the copy check box 306 is unchecked, the copy flag is turned off. Further, the copy content group merely means a set of all contents that can be reproduced by the terminal device 20.

Thereafter, a content list for display is generated from the list of all the contents generated in step S403 (step S406). Then, to the contents belonging to the moving content group generated in step S412 in the content list, vacant synchronization check boxes are added (step S425). The moving check box of the content of which moving flag is on from among the vacant check boxes is checked (step S426). In addition, a vacant copy check box is added to the content belonging to the copy content group generated in step S423 (step S427). Then, among the vacant copy check boxes, the copy check box of the content of which copy flag is on is checked (step S428).

Thereafter, the management screen 300 is displayed on the display 109 (step S409). The content list 303 including the copy check box 306 and the moving check box 307 is displayed on the management screen 300 (step S410), and the processing returns to the upper routine.

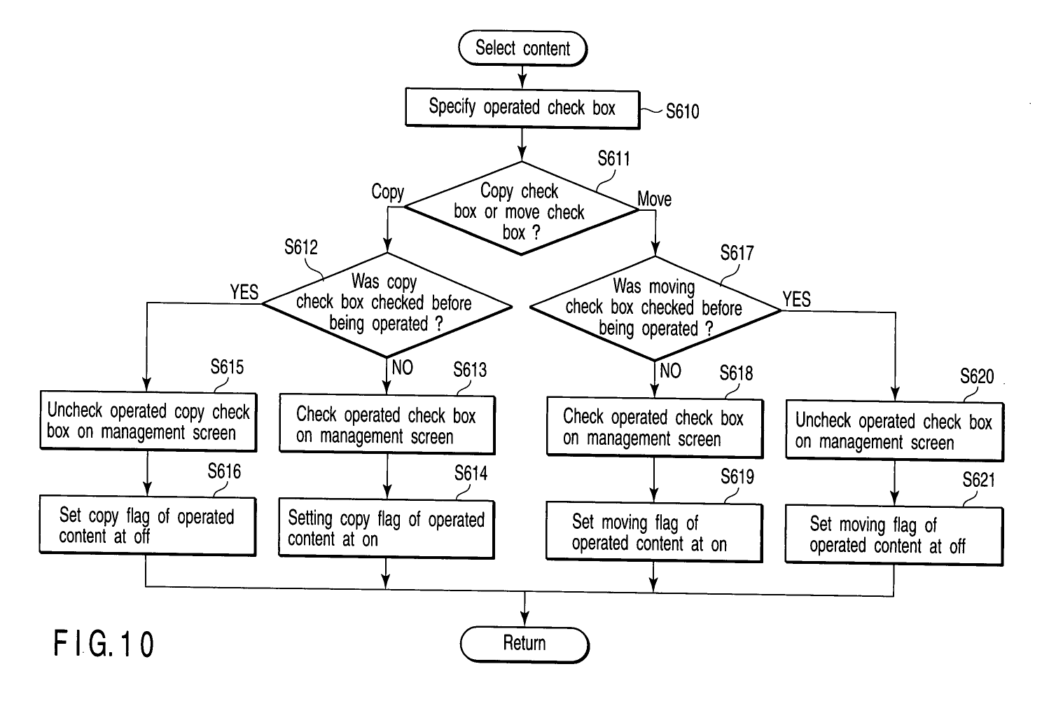

In the content selection subroutine invoked in step S6, first, the operated check box is specified as shown in FIG. 10 according to the embodiment (step S610). Then, it is discriminated that the specified synchronization check box is the copy check box 306 or the moving check box 307 (step S611).

If the copy check box 306 is operated, it is discriminated whether or not the copy check box 306 was checked before it is operated (step S612). If it was not checked before the operation, the operated copy check box 306 on the management screen 300 displayed on the display 109 by the display unit 107 is checked (step S613). Then, after setting the copy flag of the operated content at on (step S614), the processing returns to the upper routine. In addition, in the case where it is discriminated that the copy check box 306 was checked before the operation in step S612, the operated copy check box 306 on the management screen 300 displayed on the display 109 by the display unit 107 is unchecked (step S615). Then, after setting the copy flag of the operated content at off (step S616), the processing returns to the upper routine.

On the other hand, if it is discriminated that the moving check box 307 is operated in the step S611, it is discriminated whether or not the moving check box 307 was checked before it is operated (step S617). Here, if it was not checked before the operation, the operated moving check box 307 on the management screen 300 displayed on the display 109 by the display unit 107 is checked (step S618). Then, after setting the moving flag of the operated content at on (step S619), the processing returns to the upper routine. In addition, in the case where it is discriminated that the moving check box 307 was checked before the operation in step S617, the operated moving check box 307 on the management screen 300 displayed on the display 109 by the display unit 107 is unchecked (step S620). Then, after setting the moving flag of the operated content at off (step S621), the processing returns to the upper routine.

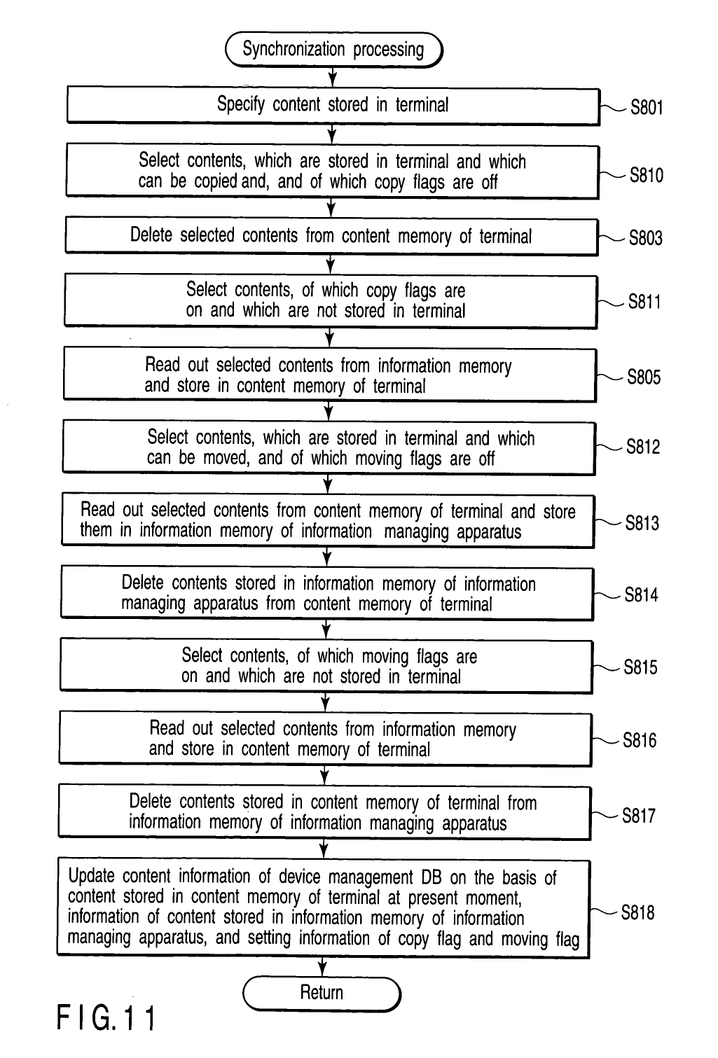

In the synchronization processing subroutine invoked in the step S8, first, the information of the content stored in the content memory 205 of the terminal device 20 is acquired from the terminal device 20 via the communication unit 106 to specify the content actually stored in the terminal device 20 as shown in FIG. 11 according to the embodiment (step S801). This is because the terminal device 20 may delete the content independently, and the information of the contents stored in the content memory 205 of the device content information 104A2 does not coincide with the information actually stored in the content memory 205 of the terminal device 20.

Thereafter, the contents are selected, which are stored in the terminal device 20, which can be copied, and of which copy flags are off (step S810). Then, the selected contents are deleted from the content memory 205 of the terminal device 20 (step S803). Next, the contents are selected, of which copy flags are on and which are not stored in the content memory 205 of the terminal device 20 (step S811). Then, the selected contents are read out from the information memory 105, and stored in the content memory 205 of the terminal device 20 (step S805).

Subsequently, the contents are selected, which are stored in the terminal device 20, which can be moved, and of which moving flags are off (step S812). Then, the selected contents are read out from the content memory 205 of the terminal device 20 and stored in the information memory 105 of the information managing apparatus 10 (step S813). Thereafter, the contents stored in the information memory 105 of the information managing apparatus 10 are deleted from the content memory 205 of the terminal device 20 (step S814). Thus, the content of which moving check box 307 is unchecked is moved from the terminal device 20 to the information managing apparatus 10. In the meantime, reading out of the content in step S813 is actually carried out by receiving the relevant content when the content transmission request is transmitted from the communication unit 106 to the terminal device 20 and then the processing unit 201 of the terminal device 20 having received this request reads out and transmits the relevant content from the content memory 205.

Next, the contents are selected, of which moving flags are on and which are not stored in the content memory 205 of the terminal device 20 (step S815). Then, the selected contents are read out from the information memory 105, and stored in the content memory 205 of the terminal device 20 (step S816). Thereafter, the contents stored in the content memory 205 of the terminal device 20 are deleted from the information memory 105 of the information managing apparatus 10 (step S817). In this manner, the content of which moving check box 307 is checked is moved from the information managing apparatus 10 to the terminal device 20.

Then, the device content information 104A2 of the terminal device 20 of the device management DB 104 is updated on the basis of the content stored in the content memory 205 of the terminal device 20 at the present moment, the information of the content stored in the information memory 105 of the information managing apparatus 10, the copy flag, and the moving flag (step S818), and the processing returns to the upper routine.

As described above, according to the information managing apparatus 10 of the second embodiment of the invention, content movement can be selected with respect to the content that cannot be copied due to a copyright.

In the meantime, according to the first and second embodiments, it is assumed that various control programs such as the information managing program are stored in the program memory 103 in advance. The various control programs may be provided by a recording medium such as a CD-ROM so as to be read from the recording medium and stored in the program memory 103. Further, by downloading various programs recorded in an external recording medium via a network such as the Internet and a LAN, they may be stored in the program memory 103.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An information managing apparatus comprising:
a communication unit configured to transmit and receive information to and from an information reproducing apparatus having a content memory configured to store a plurality of multimedia contents and a content reproducing unit configured to reproduce the contents;
an information memory configured to store information including the multimedia contents;
an information managing database configured to store information on the contents stored by the content memory of the information reproducing apparatus and information on the contents stored by the information memory;
a content managing unit configured to manage the contents stored in the content memory of the information reproducing apparatus connected to the communication unit, on the basis of the information stored in the information managing database; and
a content type acquiring means configured to acquire from the information reproducing apparatus information on the type of the content that can be reproduced by the content reproducing unit of the information reproducing apparatus, wherein the content managing unit extracts from the information memory the contents acquired by the content type acquiring means that are types reproducible by the content reproducing unit of the information reproducing apparatus but that are not stored in the content memory of the content reproducing unit from among the contents stored in the information memory, on the basis of the information managing database, and
transmits to the information reproducing apparatus by the communication unit one of all of the extracted contents and a part of contents which is selected by user from among the extracted contents.

2. The apparatus according to claim 1, further comprising:
a display configured to display information;
an index display unit configured to display indexes of the contents on the display; and
an index selecting unit configured to select at least one index displayed on the display by the index display unit, wherein
the index display unit displays the index of the content managed by the content managing unit on the display by the index display unit, and
among the indexes displayed on the display, the index display unit displays the index of the information that can be reproduced by the content reproducing unit of the information reproducing apparatus and the index of the information that cannot be reproduced by the content reproducing unit of the information reproducing apparatus with their display modes being different.

3. The apparatus according to claim 2, wherein the index selecting unit is selectable the index of the content that can be reproduced by the content reproducing unit of the information reproducing apparatus and not selectable the index of the content that cannot be reproduced by the content reproducing unit of the information reproducing apparatus from among the indexes displayed on the display.

4. The apparatus according to claim 2, wherein the index display unit displays the index of the content that cannot be reproduced by the content reproducing unit of the information reproducing apparatus with any of a lower brightness and a lower saturation as compared to the index of the content that can be reproduced by the content reproducing unit of the information reproducing apparatus.

5. The apparatus according to claim 3, wherein the index display unit displays a selection field in the index of the content that can be reproduced by the content reproducing unit of the information reproducing apparatus.

6. The apparatus according to claim 2, wherein the content managing unit includes a copyright information determining unit configured to read copyright managing information attached to the content and to determine allowance of one of copying and moving of the content on the basis of the read copyright managing information, and
the index display unit displays the indexes of the contents with their display mode being different in accordance with an allowance state of one of copying and moving of the contents determined by the copyright information determining unit.

7. The apparatus according to claim 6, wherein the index display unit displays the content that cannot be copied and moved with the index of the mode that cannot be selected by the index selecting unit, and
with respect to the content that can be only moved selected by the index selecting unit, the content managing unit transmits the content that can be only moved from the communication unit to the information reproducing apparatus, and then, deletes the transmitted content from the information memory.

8. The apparatus according to claim 1, wherein the content includes at least one of image content, video content, and voice content.

9. An information managing program to be executed by an information managing apparatus comprising: a communication unit configured to transmit and receive information to and from an information reproducing apparatus having a content memory configured to store a plurality of multimedia contents and a content reproducing unit configured to reproduce the contents; an information memory configured to store information including the multimedia contents; and an information managing database configured to store information on the contents stored by the content memory and information on the contents stored by the information memory, the information managing program comprising:
connecting the information managing apparatus to the information reproducing apparatus by the communication unit;
acquiring information on a type of the content that can be reproduced by the content reproducing unit of the information reproducing apparatus from the connected information reproducing apparatus;
selecting the contents that are types reproducible by the content reproducing unit of the information reproducing apparatus but that are not stored in the content memory of the information reproducing apparatus from among the contents stored in the information memory on the basis of the information managing database;
extracting the selected contents from the information memory; and
transmitting to the information reproducing apparatus one of the all of extracted contents and a part of contents which is selected by user from among the extracted contents.

10. The program according to claim 9, wherein
the selecting the contents includes displaying indexes of the contents stored in any of the content memory of the information reproducing apparatus and the information memory, and
the displaying indexes includes displaying the index of the content that can be reproduced by the content reproducing unit of the information reproducing apparatus and the index of the content that cannot be reproduced by the content reproducing unit of the information reproducing apparatus with their display modes being different.

11. The program according to claim 10, further comprising selecting at least one index from the displayed indexes, wherein
among the indexes displayed, the index of the content that can be reproduced by the content reproducing unit of the information reproducing apparatus is selectable by selecting the index and the index of the content that cannot be reproduced by the content reproducing unit of the information reproducing apparatus is not selectable by selecting the index.

12. The program according to claim 10, wherein, among the displayed indexes, the index of the content that cannot be reproduced by the content reproducing unit of the information reproducing apparatus is displayed with any of a lower brightness and a lower saturation as compared to the index of the content that can be reproduced by the content reproducing unit of the information reproducing apparatus.

13. The program according to claim 11, wherein the displaying indexes displays a selection field in the index of the content that can be reproduced by the content reproducing unit of the information reproducing apparatus.

14. The program according to claim 10, further comprising reading copyright managing information attached to the content and determining allowance of one of copying and moving of the content on the basis of the read copyright managing information,
wherein the displaying indexes displays the indexes of the contents with their modes of display being different in accordance with an allowance state of one of copying and moving of the determined contents.

15. The program according to claim 14, wherein the displaying indexes displays the content that can be copied and moved with the index of the mode that cannot be selected, and
the program further comprises, with respect to the content that can be only moved selected by selecting the index, transmitting the content that can be only moved from the communication unit to the information reproducing apparatus, and then, deleting the transmitted content from the information memory.

16. The program according to claim 9, wherein the content includes at least one of image content, video content, and voice content.

17. A recording medium that can be read by a computer comprising: a communication unit configured to transmit and receive information to and from an information reproducing apparatus having a content memory configured to store a plurality of multimedia contents and a content reproducing unit configured to reproduce the contents; an information memory configured to store information including the multimedia contents; and an information managing database configured to store information on the contents stored by the content memory and information on the contents stored by the information memory, and that stores therein a program including commands that makes the computer execute:
connecting to the information reproducing apparatus by the communication unit;
acquiring information on a type of the content that can be reproduced by the content reproducing unit of the information reproducing apparatus from the connected information reproducing apparatus;
selecting the contents that are types reproducible by the content reproducing unit of the information reproducing apparatus but that are not stored in the content memory of the information reproducing apparatus from among the contents stored in the information memory on the basis of the information managing database;
extracting the selected contents from the information memory; and
transmitting to the information reproducing apparatus one of all of the extracted contents and a part of contents which is selected by user from among the extracted contents.

18. An information managing apparatus comprising:
communication means for transmitting and receiving information to and from an information reproducing apparatus having first storage means for storing a plurality of multimedia contents and content reproducing means for reproducing the contents;
second storage means for storing information including the multimedia contents;
an information managing database for storing information on the contents stored by the first storage means of the information reproducing apparatus and information on the contents stored by the second storage means;
content managing means for managing the contents stored in the first storage means of the information reproducing apparatus connected to the communication means, on the basis of the information stored in the information managing database; and
content type acquiring means for acquiring from the information reproducing apparatus information on the type of the content that can be reproduced by the content reproducing means of the information reproducing apparatus, wherein
the content managing means extracts from the second storage means the contents acquired by the content type acquiring means that are types reproducible by the content reproducing means of the information reproducing apparatus but that are not stored in the first storage means of the content reproducing means from among the contents stored in the second storage means, on the basis of the information managing database, and
transmits to the information reproducing apparatus by the communication means one of all of the extracted contents and a part of contents which is selected by user from among the extracted contents.

19. An information managing program to be executed by an information managing apparatus comprising: a communication means for transmitting and receiving information to and from an information reproducing apparatus having a first storage means for storing a plurality of multimedia contents and content reproducing means for reproducing the contents; second storage means for storing information including the multimedia contents; and an information managing database for storing information on the contents stored by the first storage means and information on the contents stored by the second storage means, the information managing program comprising:
connecting the information managing apparatus to the information reproducing apparatus by the communication means;
acquiring information on a type of the content that can be reproduced by the content reproducing means of the information reproducing apparatus from the connected information reproducing apparatus;
selecting the contents that are types reproducible by the content reproducing means of the information reproducing apparatus but that are not stored in the first storage means of the information reproducing apparatus from among the contents stored in the second storage means on the basis of the information managing database;
extracting the selected contents from the second storage means; and
transmitting to the information reproducing apparatus one of all of the extracted contents and a part of contents which is selected by user from among the extracted contents.

20. A recording medium that can be read by a computer comprising: communication means for transmitting and receiving information to and from an information reproducing apparatus having first storage means for storing a plurality of multimedia contents and content reproducing means for reproducing the contents; second storage means for storing information including the multimedia contents; and an information managing database for storing information on the contents stored by the first storage means and information on the contents stored by the second storage means, and that stores therein a program including commands that makes the computer execute:
connecting to the information reproducing apparatus by the communication means;
acquiring information on a type of the content that can be reproduced by the content reproducing means of the information reproducing apparatus from the connected information reproducing apparatus;
selecting the contents that are types reproducible by the content reproducing means of the information reproducing apparatus but that are not stored in the first storage means of the information reproducing apparatus from among the contents stored in the second storage means on the basis of the information managing database;
extracting the selected contents from the second storage means; and
transmitting to the information reproducing apparatus one of all of the extracted contents and a part of contents which is selected by user from among the extracted contents.
